(19) United States
(12) Patent Application Publication
(10) Pub. No.: US 2012/0085250 A1
(43) Pub. Date: Apr. 12, 2012

(54) NOVEL METHOD OF TREATING TEXTILES WITH STARCH TO ELIMINATE STICKING

(75) Inventors: Max M. Guzman, Farmington, MN (US); Matthew A. Bilski, St. Paul, MN (US); Eddie D. Sowle, Woodbury, MN (US); Carrie L. Armstrong, Forest Lake, MN (US)

(73) Assignee: ECOLAB USA INC., ST. PAUL, MN (US)

(21) Appl. No.: 12/902,668

(22) Filed: Oct. 12, 2010

(51) Int. Cl. B30B 13/00

(52) U.S. Cl. 100/38

(57) ABSTRACT

A method of treating textiles is disclosed. In an embodiment the method involves applying a liquid combination comprising ethoxylated starch, silicon dioxide, and water to damp textiles, allowing the liquid combination to contact the textiles for a discrete amount of time before draining excess liquid from the textiles, and pressing the textiles using heat. The method of the invention reduces sticking and gumming of the starch on a pressing device such as an iron.

### FIELD

The present invention relates to a method for treating textiles in order to apply starch and reduce sticking when pressing or ironing the textiles. The method is particularly useful in the industrial or institutional settings due to the volume of textiles processed daily and the extremely elevated temperatures of the pressing devices. More particularly, the present invention relates to a method for applying a liquid combination including starch to a textile followed by pressing or ironing.

### BACKGROUND

Institutional pressing devices must be able to press large volumes of textiles in reduced amounts of time. These devices include rollers as found in Kannegiesser brand rollers or large plates as found in dry cleaning operations to name a couple. Rollers are useful in pressing very large linens or textiles such as bed linens including sheets and pillowcases; table linens including table cloths, napkins, and placemats; and chair covers to name a few.

Whenever starch is applied to textiles, the user risks that the starch will become tacky and stick to the pressing device, whether it be a roller, a plate, or a consumer/residential iron. As one can appreciate, the sticking may result in unsightly brown patches on the textile where the starch has burnt and adhered to the linen. Even if a burnt starch stain does not remain on the linen, the pressing device may adhere to the linen. In the case of the industrial rollers, this causes the textile to bunch up leaving pressed wrinkles, either accordion-shaped or otherwise in the linen. Such wrinkles are unsightly and very difficult or impossible to remove by passing the linen through the roller a second time. Instead, the linen is ideally put through the entire wash cycle again in order to wet the linen thereby removing the pressed wrinkles This is time consuming and costly.

Starch is applied to linens to impart a particular feel or stiffness to the fabric. Starch may also be applied to linens to allow a linen to retain a particular fold or appearance once it has been folded. Such is the case with respect to table linens such as napkins. Napkins are often folded into decorative shapes. The stiffness of the fabric allows for more elaborate or different shapes of folds.

The present invention aims to reduce the likelihood of starched textiles sticking to the pressing device.

### SUMMARY

In an embodiment the present invention provides a method of treating textiles, including dispensing a liquid combination of ethoxylated starch, silicon dioxide, and water onto damp textiles, allowing the liquid combination to contact the textiles for a discrete length of time, draining excess liquid from the textiles, and pressing the textiles using heat. Depending upon the fabric content of the textiles, the liquid combination may optionally include polyvinyl acetate. The liquid combination includes up to about 10 weight % silicon dioxide and up to about 15 weight % ethoxylated starch and has a viscosity of less than about 3,000 cps. Depending upon the desired feel or stiffness of the pressed linens, in another embodiment the liquid combination includes up to about 40 weight % of ethoxylated starch.

The textiles useful in a method of the invention may be manufactured substantially from synthetic materials, natural materials, or a combination thereof. In an embodiment of the method of the invention the liquid combination is drained from the textiles before pressing occurs. This draining step may include spinning the textiles to remove excess liquid. In an embodiment, the textiles remain damp before the pressing step and are substantially dry afterwards.

The liquid combination may be provided to the damp textiles in a concentration up to about 40 ounces per pound of dry textiles. The liquid combination may originally be provided as a liquid or it may be achieved by diluting with water a solid composition of ethoxylated starch and silicon dioxide. After dispensing the liquid combination onto the textiles, it may remain in contact with the damp textiles for a length of time up to about 2 minutes before the draining step. The dispensing of the liquid combination does not include aerosol spraying. In other words, aerosol spraying is excluded from the dispensing method of the invention.

The liquid combination may optionally include additional ingredients such as fragrances, brightening agents, anti-static agents, anti-wrinkling agents, dye transfer inhibition/color protection agents, odor removal/odor capturing agents, ultraviolet light protection agents, water repellency agents, insect repellency agents, anti-pilling agents, souring agents, mildew removing agents, enzymes, allergicide agents, and mixtures thereof.

A method of treating textiles is disclosed. The method includes dispensing a combination comprising ethoxylated starch, silicon dioxide, and water on damp textiles wherein the dispensing step is not accomplished via aerosol spray and pressing the textiles using heat.

The invention further teaches a method of treating textiles, including preparing a liquid composition comprising water and up to about 12 weight percent actives ethoxylated starch, up to about 6 weight percent actives silicon dioxide, and up to about 4 weight percent actives polyvinyl acetate; applying the liquid composition to damp textiles via a method other than aerosol spraying; and pressing the damp textiles using heat. Surprisingly, the method of the invention results in reduced sticking or adherence of the starch-coated linen onto the pressing device.

### DETAILED DESCRIPTION OF SOME EMBODIMENTS OF THE INVENTION

As used herein the terms “textiles” and “linens” are used interchangeably and refer to any fabric item suitable for washing and pressing. The terms include items manufactured substantially from natural materials such as cotton, silk, linen, wool, hemp, ramie and jute to name a few. The terms also include items manufactured substantially from synthetic materials including polyester rayon, acetate, nylon, modacrylic, olefin, acrylic, carbon fiber, vinyon, saran, modal, and polybenzimidazole fiber, sulfar, orlon, and acrylonitrile rubber to name a few. Textiles processed according to the invention may be manufactured from a combination of natural and synthetic fibers or materials. Such fabrics are often referred to as “blends.” The term, “textiles” includes woven fabrics and nonwoven webs. The term, “textiles,” includes but is not limited to garments such as pants, shirts, ties, scarves, coats, jackets, skirts, dresses and the like; table linens such as table cloths, table runners, placemats, and napkins; bed linens such as sheets, blankets, and pillow cases; kitchen towels; and furniture covers such as chair covers or sofa covers.

The term, “pressing device” as used herein encompasses all heated devices ordinarily used to press textiles. These include but are not limited to irons, presses, and rollers. The pressing device may be heated to a temperature of up to about 200° F., up to about 300° F., and up to about 400° F. As one skilled in the art may appreciate, the fabric composition of the textile being pressed may determine the heat setting of the pressing device. That is, when pressing a fragile fabric such as silk the temperature of the pressing device will be substantially lower than when pressing a more durable fabric comprised of cotton. Likewise, the temperature of the pressing device will be determined so as not to melt or burn the fabric.

The term, “dispensing” as used herein refers to applying a liquid to a textile via any method other than aerosol spraying. That is, dispensing may occur via pouring, spraying the liquid through a hose or nozzle as long as an aerosol spray is not generated, or squirting. Alternatively, the textiles may be added to a standing volume of the liquid thereby immersing the textiles in a volume of the liquid. “Dispensing,” for the purposes of this invention includes any method known to apply liquids to a surface other than aerosol spraying.

“Draining,” for the purposes of this invention includes but is not limited to pouring the liquid from the textiles, emptying a volume of liquid from a container by removing a plug, or spinning to name a few methods. The invention anticipates that any known method of removing liquid from textiles may be practiced in the method.

As used herein, a solid cleaning composition refers to a cleaning composition in the form of a solid such as a powder, a particle, an agglomerate, a flake, a granule, a pellet, a tablet, a lozenge, a puck, a briquette, a brick, a solid block, a unit dose, or another solid form known to those of skill in the art. The term “solid” refers to the state of the combination under the expected conditions of storage and use of the solid combination. In general, it is expected that the combination will remain in solid form when exposed to temperatures of up to about 100° F. and greater than about 120° F.

By the term “solid” as used to describe the processed composition, it is meant that the hardened composition will not flow perceptibly and will substantially retain its shape under moderate stress or pressure or mere gravity, as for example, the shape of a mold when removed from the mold, the shape of an article as formed upon extrusion from an extruder, and the like. The degree of hardness of the solid cast composition can range from that of a fused solid block, which is relatively dense and hard, for example, like concrete, to a consistency characterized as being malleable and sponge-like, similar to caulking material.

As used herein, weight percent (wt-%), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

The method of the invention is useful in the industrial or institutional market as well as in a residential setting. The invention provides a method of applying a starch composition to linens to reduce sticking of the pressing device to starch-coated linens. The method of the invention is particularly useful when laundering and pressing large volumes of textiles as is oftentimes found in large industrial, institutional or commercial settings. Industrial, institutional or commercial settings include but are not limited to commercial launderers; hospitals or other healthcare settings such as nursing homes, or rehabilitation homes; hotels, motels and the like.

Linens are laundered via known methods. In an embodiment of the invention while the linens are still wet, a liquid composition comprising ethoxylated starch and silicon is dispensed or applied to the linens. The liquid composition is allowed to contact the surface of the linens before the composition is drained. In an embodiment the liquid combination is provided in the final rinse step of the wash process. Once drained, the linens are ready for pressing via any known means. The method of the invention is particularly useful when the pressing is done via a heated device such as an iron, a press, or rollers. The combination of ethoxylated starch and silicon have surprisingly been found to reduce sticking of the starch-coated linens to the heated pressing device.

Without being bound by theory, it is believed that the particular combination of ethoxylated starch and silicon are useful because the ethoxylation of the starch enables the starch to more easily disperse in water thereby allowing the starch to dispense onto the linens more readily. Once on the linens, and once heat is applied to press the linens, it is believed that the silicon provides nucleation sites for the evaporating water allowing the water to evaporate more readily. Another theory is that the silicon reduces the surface tension of the water on the surface of the linens allowing the water to more readily evaporate. Whatever the theory, it has surprisingly been found that the combination of ethoxylated starch and silicon reduces the sticking of the starch-coated linens to the heated surface.

The ethoxylated starch is added to the liquid combination in an amount up to about 6 weight percent, up to about 8 percent weight percent, up to about 10 weight percent, and up to about 12 weight percent actives. The amount of ethoxylated starch may be increased depending upon the overall feel or “hand” desired for the finished, pressed linen. The amount of ethoxylated starch may be increased to the point that the viscosity of the liquid combination does not become too viscous to dispense onto the liquids. In an embodiment the viscosity of the liquid combination is less than about 3,000 cps, less than about 2,700 cps, less than about 2,500 cps, less than about 2,000 cps.

Another component that is optionally included in the liquid combination is a sizing agent such as polyvinyl acetate. Polyvinyl acetate is included in the liquid combination when treating synthetic fabrics. Without being bound by theory, it is believed that the polyvinyl acetate allows the starch to more readily adhere to the synthetic fabrics such as polyester or polyester blends. The skilled artisan will recognize that other sizing agents may be used in place of or in addition to the polyvinyl acetate. These additional sizing agents include but are not limited to polyacrylic acid, and polyvinyl alcohols. The sizing agent is added in an amount up to about 1, up to about 2, up to about 3, and up to about 4 weight percent actives.

Another benefit of practicing a method of the present invention is that highlighting on the linens is reduced. Highlighting is referred to as the spotting or globbing of large deposits of starch on a linen's surface. Once dried and pressed, these deposits of starch are visible and referred to as “highlights.” As one can appreciate, such highlighting is unsightly and undesirable.

Any form of silicon may be included in the liquid combination. In an embodiment, silicon dioxide is used due to its wide availability and relative low cost. Silicon dioxide is included in the liquid combination in an about up to about 6 weight percent, up to about 5.5 weight percent, up to about 5.0 weight percent, up to about 4.5 weight percent, up to about 4.0 weight percent, up to about 3.5 weight percent, and up to about 3.0 weight percent actives.

The ratio of ethoxylated starch to silicon dioxide is in the range of from about 1 part starch to about 0.05 parts silicon dioxide up to about 2 parts starch to about 0.5 parts silicon dioxide.

In an embodiment of the invention the linens remain in a washing machine after the wash cycle is complete. The liquid combination is then added in the wash wheel and applied to the clean but still damp linens. The liquid combination is applied via any means useful to apply a large volume of liquid onto a large volume of linens. In an embodiment the liquid combination is applied in an amount of up to about 0.2, up to about 0.3, up to about 0.4, up to about 0.5 ounces per pound of dry linens. As one may appreciate, when the liquid combination is applied the linens are wet or damp; however, the calculation of how much starch to add to the linens is accomplished while the linens are dry. That is, the operator knows the weight of the dry linens and thereby applies the suitable amount of liquid combination based on the dry weight of the linens.

Yet an additional benefit of an embodiment of the invention is that it allows a launderer to apply greater amounts of starch to linens without the worries of sticking or gumming of the pressing device, or highlighting of the starch onto the linens.

The liquid combination of ethoxylated starch and silicon is diluted using water. The combination is added to the linens as a liquid to allow easy and rapid dispersion of the combination onto the linens. However, the invention anticipates that the ethoxylated starch and silicon and the optional sizing agent may be in the form of a solid. Water is then used to dissolve the solid and prepare the liquid combination before dispensing onto the linens. Dissolving the solid may be accomplished by placing a powdered solid into a volume of water or by spraying water onto a solid block and thereby dissolving a portion of the block. Such dispensing systems are described and explained in U.S. Pat. Nos. 5,255,820; 6,763,860; 6,773,668; 7,390,467; 7,410,623; 7,584,762; 7,615,122; 7,694,589; and 7,708,023 to name a few, the complete disclosures of which are hereby incorporated by reference for all purposes.

The liquid combination may be dispensed via pouring, spraying the liquid through a hose or nozzle as long as an aerosol spray is not generated, or squirting. In particular, a propellant is not used when applying the liquid combination to the textiles. Alternatively, the textiles may be added to a standing volume of the liquid thereby immersing the textiles in a volume of the liquid. Dispensing is accomplished via any method known to apply liquids to a surface other than aerosol spraying. As one may appreciate, an aerosol spray is inefficient when applying a large volume of liquid to a large volume of linens. Moreover, during dispensing the linens are most likely in a large heap instead of being laid out smoothly. Therefore, it is advantageous to use a quick, economical method of dispensing or applying the liquid combination to the liquids such as dumping, pouring, immersing, squirting or the like.

Up to about 1 gallon of the diluted liquid combination diluted with water is applied per dry pound of linens according to an embodiment of the invention. Therefore, a large volume of the liquid combination is added to an industrial or institutional-size washing machine. If a washing machine can accommodate up to about 40 pounds of dry linens, up to about 40 gallons of the liquid combination is added to the washed linens.

Other optional additional ingredients that may be added to the liquid combination include but are not limited to liquid combination further comprises an additional ingredient selected from the group consisting of fragrances, brightening agents, anti-static agents, anti-wrinkling agents, dye transfer inhibition/color protection agents, odor removal/odor capturing agents, ultraviolet light protection agents, water repellency agents, insect repellency agents, anti-pilling agents, souring agents, mildew removing agents, enzymes, allergicide agents, and mixtures thereof.

The invention anticipates that the method of the invention may be practiced upon dry linens. This may be the case when the linens are otherwise clean but have become unsuitably wrinkled due to extended holding time while folded, mistreatment of the folded linens or any other reason. In this case the liquid combination would be applied to dry linens. Care must be taken, however, to account for the amount of starch already present on the linens so as not to have too stiff of linens after practicing the method of the invention. If the liquid combination of the invention was not used during the previous processing of the linens, and the linens were previously starched, additional silicon may be added to the liquid combination to compensate for the additional starch previously deposited onto the linens.

The liquid combination is allowed to contact the linens for a discrete amount or length of time. This length of time may last for up to about 5 minutes, up to about 4 minutes, up to about 3 minutes, up to about 2 minutes, up to about 1.5 minutes, up to about 1 minute, or up to about 30 seconds. In an embodiment the exposure time of the liquid combination to the linens lasts between about 60 and 150 seconds, and between about 90 and 120 seconds. As one may appreciate, the actual time that the liquid combination actually contacts a section of the linens may be instantaneous; however, the discrete amount of contact time is provided to ensure that every centimeter of the linens is coated with the liquid combination. During the contact time the linens may be tossed, mixed, or tumbled to allow the liquid combination to evenly disperse over and into the linens.

Once the liquid combination is applied to the linens and allowed to contact the linens, it is drained from the linens to eliminate any excess liquid. In an embodiment of the invention the next step is to press the linens which is accomplished under the high temperatures of the pressing device. The pressing step also serves to dry the linens. Therefore, it is important to eliminate as much water from the linens as possible before the pressing step is undertaken. The water elimination is accomplished by any suitable means. The largest amount of liquid is simply drained off of the linens. If the linens remain in the washing machine, the linens are spun to remove as much excess liquid from the linens as possible.

Once the excess liquid has been removed from the linens, the linens are then ready to be pressed. In order to fully appreciate the benefits of the invention, a heated pressing device is used. The linens are either pressed using a press, iron, or roller device. The pressing device may be heated to a temperature of up to about 200° F., up to about 300° F., and up to about 400° F. As one skilled in the art may appreciate, the fabric composition of the textile being pressed may determine the heat setting of the pressing device. That is, when pressing a fragile fabric such as silk the temperature of the pressing device will be substantially lower than when pressing a more durable fabric such as cotton.

The invention has been described with reference to various specific and preferred embodiments and techniques. However, it should be understood that many variations and modifications may be made while remaining within the spirit and scope of the invention.

We claim:

1. A method of treating textiles, comprising the steps of:
dispensing to damp textiles a liquid combination comprising ethoxylated starch, silicon dioxide, and water;
allowing the liquid combination to contact the textiles for a discrete length of time;
draining excess liquid from the textiles;
and pressing the textiles using heat.

2. The method of claim 1 wherein the liquid combination further comprises a sizing agent.

3. The method of claim 1 wherein the liquid combination comprises up to about 10 weight % silicon dioxide and up to about 15 weight % ethoxylated starch.

4. The method of claim 1 wherein the liquid combination has a viscosity of less than about 3,000 cps.

5. The method of claim 2 wherein the liquid combination comprises up to about 40 weight % of the ethoxylated starch.

6. The method of claim 2 wherein the textiles are comprised substantially of synthetic materials.

7. The method of claim 1 wherein the textiles are comprised substantially of natural materials.

8. The method of claim 1 wherein the draining step is comprised of spinning the textiles to remove excess liquid.

9. The method of claim 1 wherein the textiles are damp during the pressing step.

10. The method of claim 1 wherein the liquid combination is provided to the damp textiles in a concentration up to about 40 ounces per pound of dry textiles.

11. The method of claim 1 wherein the liquid combination is achieved by diluting with water a solid composition comprised of ethoxylated starch and silicon dioxide.

12. The method of claim 1 wherein the liquid combination is provided to the damp textiles for a length of up to about 20 minutes before the draining step.

13. The method of claim 1 wherein the dispensing step does not comprise aerosol spraying.

14. The method of claim 1 wherein the liquid combination further comprises an additional ingredient selected from the group consisting of fragrances, brightening agents, anti-static agents, anti-wrinkling agents, dye transfer inhibition/color protection agents, odor removal/odor capturing agents, ultraviolet light protection agents, water repellency agents, insect repellency agents, anti-pilling agents, souring agents, mildew removing agents, enzymes, allergicide agents, and mixtures thereof.

15. The method of claim 2 wherein the sizing agent is comprised of polyvinyl acetate.

16. A method of treating textiles, comprising:
dispensing to damp textiles a combination, the combination comprising:
ethoxylated starch, silicon dioxide, and water;
wherein the dispensing step is not accomplished via aerosol spray, and the textiles are pressed using heat after dispensing.

17. The method of claim 16 wherein the liquid combination further comprises polyvinyl acetate.

18. The method of claim 16 further comprising the step of draining excess liquid from the textiles before pressing the textiles.

19. A method of treating textiles, comprising the steps of
a) preparing a liquid composition comprising water and up to about 12 weight percent actives ethoxylated starch, up to about 6 weight percent actives silicon dioxide, and up to about 4 weight percent actives polyvinyl acetate;
b) applying the liquid composition to damp textiles via a method other than aerosol spraying; and
c) pressing the damp textiles using heat.

20. The method of claim 19 wherein the liquid combination has a viscosity of less than about 3,000 cps.

21. The method of claim 19 wherein the textiles are comprised substantially of synthetic materials or are comprised substantially of natural materials, or a combination thereof.

22. The method of claim 19 further comprising the step of draining excess liquid from the textiles before pressing the textiles.

23. The method of claim 22 wherein the draining step is comprised of spinning the textiles to remove excess liquid.

24. The method of claim 19 wherein the textiles are damp during the pressing step.

25. The method of claim 19 wherein the liquid combination is provided to the damp textiles in a concentration up to about 40 ounces per pound of dry textiles.

26. The method of claim 19 wherein the liquid combination is achieved by diluting with water a solid composition comprised of ethoxylated starch, silicon dioxide, and polyvinyl acetate.

27. The method of claim 19 wherein the liquid combination is provided to the damp textiles for a length of up to about 20 minutes before pressing the textiles.
